(19) United States
(12) Patent Application Publication
(10) Pub. No.: US 2024/0359675 A1
(43) Pub. Date: Oct. 31, 2024

(54) WHEEL-SPECIFIC, ELECTROHYDRAULIC BRAKE ACTUATOR; METHOD FOR CONTROLLING A WHEEL-SPECIFIC, ELECTROHYDRAULIC BRAKE ACTUATOR AND ELECTRONICALLY SLIP-CONTROLLABLE VEHICLE BRAKE SYSTEM HAVING WHEEL-SPECIFIC, ELECTROHYDRAULIC BRAKE ACTUATORS

(71) Applicant: Robert Bosch GmbH, Stuttgart (DE)

(72) Inventors: Andreas Weh, Sulzberg (DE); Bertram Foitzik, Ilsfeld (DE); Michael Wilcox, Charleston, SC (US); Otmar Bussmann, Abstatt (DE); Urs Bauer, Sachsenheim (DE)

(21) Appl. No.: 18/583,604

(22) Filed: Feb. 21, 2024

(30) Foreign Application Priority Data
Apr. 27, 2023 (DE) 10 2023 203 905.2

(51) Int. Cl. B60T 13/66; B60T 13/14; B60T 13/68; B60T 17/02; B60T 17/06

(52) U.S. Cl. CPC B60T 13/662; B60T 13/148; B60T 13/686; B60T 17/02; B60T 17/06

(57) ABSTRACT

A wheel-specific, electrohydraulic brake actuator for controlling the brake pressure of a connectible wheel brake of a motor vehicle in a slip-dependent manner. A method for controlling a wheel-specific, electrohydraulic brake actuator as well as an electronically slip-controllable vehicle brake system using wheel-specific, electrohydraulic brake actuators, are also described. In the brake actuator, a pressure channel connects the brake pressure generator directly to the wheel connection.

### CROSS REFERENCE

The present application claims the benefit under 35 U.S.C. § 119 of German Patent Application No. DE 10 2023 203 905.2 filed on Apr. 27, 2023, which is expressly incorporated herein by reference in its entirety.

### BACKGROUND INFORMATION

Electronically slip-controllable brake systems of motor vehicles are available in the related art in a multitude of different forms. Their general task is to avoid wheel slip occurring in driving operation on one or multiple wheels of a motor vehicle by controlling the brake force in a wheel-specific manner and thereby to counteract unstable driving conditions of the motor vehicle.

For this purpose, vehicle brake systems having hydraulic wheel brakes have a hydraulic unit, which centrally generates a brake pressure and controls it in a wheel-specific manner. This hydraulic unit comprises a housing block, to which the individual wheel brakes are connected via brake lines for example. For generating and controlling the brake pressure, a pressure generator drivable by a motor as well as pressure medium-controlling components such as electrically controllable valves, for example, are situated on the housing block. An electronic control unit controls the motor and the valves electrically as a function of a present braking requirement or braking request and of the slip conditions prevailing on the wheels. The electronic control unit is preferably attached to the housing block. The braking requirement or the braking request may be specified by a driver by actuating a master brake cylinder and/or by a vehicle electronics system for detecting unstable and/or hazardous driving conditions of the vehicle.

In hydraulic units of modern vehicle brake systems, the master brake cylinder is integrated in the housing block of the hydraulic unit.

A vehicle brake system of this kind is described, for example, in German Patent Application No. DE 10 2021 207 848 A1.

Apart from hydraulic vehicle brake systems having a central brake pressure supply, decentralized vehicle brake systems having wheel-specific brake actuators are available in the related art. A vehicle brake system having electromechanically actuated wheel brakes is described, for example, in German Patent Application No. DE 10 2019 219 002 A1.

For generating brake forces, the brake actuators are individually electrically controlled or regulated by a control unit as a function of the present braking requirement. Vehicle brake systems of this kind are distinguished inter alia by the fact that they require less effort in the final vehicle assembly since a central hydraulic unit for generating and controlling pressure may be dispensed with and because no complex venting and initial filling of the vehicle brake system with hydraulic pressure medium is required. Naturally, in the case of electromechanical wheel brakes, there are also no problems with respect to possible leakages or pressure medium contaminated by gas.

Electromechanical wheel brakes, however, are more expensive, more voluminous and heavier in their construction at an equivalent braking power as hydraulically actuated wheel brakes. The additional weight has an effect inter alia on the suspension setup of a motor vehicle.

Apart from hydraulically or electromechanically actuated wheel brakes, electrohydraulically actuated wheel brakes are also available in the related art. In electrohydraulic wheel brakes, the brake force provided by a drive motor is transmitted hydraulically onto friction-generating means of a wheel brake.

### SUMMARY

The present invention provides, inter alia, a wheel-specific electrohydraulic brake actuator. According to an example embodiment of the present invention, such a brake actuator comprises a housing block, preferably fastened on the side of the auto body, having a motor situated on it for actuating a brake pressure generator, a pressure medium reservoir for storing pressure medium, and an electronic control unit. A plurality of channels conducting pressure medium is formed in the housing block, in particular a supply channel, a pressure channel, and a discharge channel. The pressure channel connects a working chamber of the brake pressure generator directly to a wheel connection on the housing block, that is, without hydraulic components such as valves connected in between.

According to an example embodiment of the present invention, several such brake actuators together form the vehicle brake system of a modern motor vehicle, and, due to their redundancy, ensure the brake function in the event of a failure of individual brake actuators. Brake actuators according to the present invention require only few pressure medium-controlling components and accordingly have a compact and light construction. Furthermore, brake actuators according to the present invention do not contribute to an increase in the suspended mass of a vehicle wheel, when they are fastened to the body of a vehicle.

Moreover, the brake actuators according to the present invention are suitable for an integration into so-called “corner modules”. In this case, the steering, brake and drive of a vehicle are designed in modular fashion in such a way that the individual modules are designed identically or very similarly for each corner or each wheel of a vehicle and may be integrated into a vehicle using only few standardized interfaces.

On each wheel, the brake pressure may be controlled in a wheel-specific manner using a brake actuator according to the present invention, without this resulting in hydraulic coupling effects between the brake actuators on the individual wheels, as is the case in conventional vehicle brake systems that have a central pressure supply.

Additional advantages or advantageous developments of the present invention are derived from the disclosure herein.

### BRIEF DESCRIPTION OF THE DRAWINGS

Exemplary embodiments of the present invention are shown in the figures and are explained in detail in the following description.

FIG. 1 shows a first exemplary embodiment of the present invention based on a first hydraulic circuit diagram.

FIG. 2 shows a second exemplary embodiment of the present invention based on a second hydraulic circuit diagram.

FIG. 3 shows a third exemplary embodiment of the present invention based on a third hydraulic circuit diagram.

FIG. 4 shows in greatly simplified fashion a motor vehicle including a vehicle brake system in a top view, according to an example embodiment of the present invention.

Components corresponding to one another in the individual figures have been provided with the same reference numerals.

### DETAILED DESCRIPTION OF EXAMPLE EMBODIMENTS

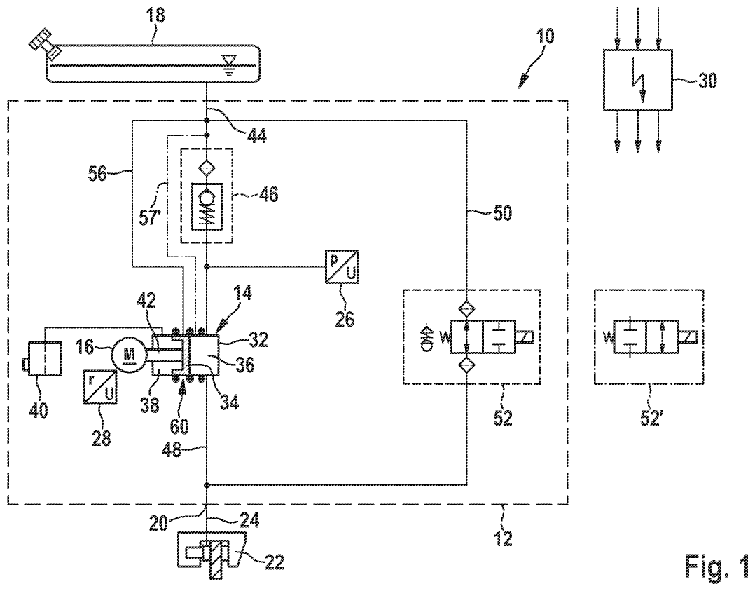

As mentioned, FIG. 1 shows a first exemplary embodiment of a wheel-specific, electrohydraulic brake actuator (10). The essential components of this brake actuator (10) are situated on or attached to a housing block (12), which is schematically indicated in the figure by an outline. These components are a brake pressure generator (14), a motor (16) for driving this brake pressure generator (14), a pressure medium reservoir (18) for supplying the brake pressure generator (14) with hydraulic pressure medium, and a wheel connection (20) formed on the housing block (12) for hydraulically contacting one of the wheel brakes (22) of a vehicle brake system e.g. via a brake line (24) or a brake hose. The brake actuator (10) furthermore comprises a pressure sensor (26) for detecting the brake pressure provided by the brake pressure generator (14), an angle-of-rotation sensor (28) for detecting an angle of rotation of the motor (16), and an electronic control unit (30) for detecting and evaluating an incoming braking request, incoming sensor signals and for electrically controlling, in accordance with demand, the explained, electrically controllable components of the brake actuator (10).

The brake pressure generator (14) on its part is formed by a unit made up of a cylinder (32) and a piston (34) displaceably accommodated in the latter, that is, a piston/cylinder unit. The piston subdivides an interior space of the cylinder (32) into a working chamber (36) fillable with pressure medium and a drive chamber (38) that is free of pressure medium and that faces the motor (16). The interior of this drive chamber (38) is vented toward the surroundings via a pressure-equalizing element (40). The drive chamber (38) accommodates a gearing, for example a spindle drive or a ball screw drive (42), by which a rotary motion of a drive shaft of the motor (16) is converted into a translatory motion of the piston (34).

The piston (34) may be driven by the motor (16) in a first direction of rotation forward, i.e., in a pressure-buildup direction, or, in an opposite direction of rotation, backward, in a pressure-reduction direction. When driving in the pressure-buildup direction, the piston (34) displaces pressure medium from the working chamber (36) in the direction of the wheel connection (20) and thus a brake pressure is built up in the connected wheel brake (22), while in the pressure-reduction direction the volume of the working chamber (36) gradually increases, so that pressure medium flows from the wheel brake (22) back into the working chamber (36) and the pressure decreases in the wheel brake. A path traveled by the piston (34) in the process is proportional to the angle of rotation of a drive shaft of the motor (16) detected by the angle-of-rotation sensor (28). This angle of rotation is used by the electronic control unit (30) to evaluate the path traveled by the piston (34), a path direction, and to ascertain the volume of pressure medium displaced as a result of the piston movement.

Various pressure medium channels are provided on the housing block (12) of the brake actuator (10), which hydraulically connect the mentioned components to one another.

A first pressure medium channel leads from the pressure medium reservoir (18) to the working chamber (36) of the brake pressure generator (14) and forms a supply channel (44). In the exemplary embodiment according to FIG. 1, a so-called plunger charging valve (46) is situated in this supply channel (44). This is a hydraulically actuated non-return valve, which allows for flow-through in a direction from the pressure medium reservoir (18) to the brake pressure generator (14) and which blocks the direction opposite thereto. The plunger charging valve (46) prevents pressure medium displaced from the working chamber (36) of the brake pressure generator (14) from flowing into the pressure medium reservoir (18) and furthermore improves the ventability of the brake actuator (10) via the wheel connection (20).

The pressure sensor (26) is connected to the supply channel (44) between the plunger charging valve (46) and the brake pressure generator (14). This pressure sensor (26) detects the pressure in the supply line (44), which corresponds to the brake pressure generated by the brake pressure generator (14). The corresponding pressure signal is, as mentioned, supplied to the electronic control unit (30).

Furthermore, a second pressure medium channel is provided on the housing block (12) of the brake actuator (10), which leads from the working chamber (36) of the brake pressure generator (14) directly to the wheel connection (20) of the housing block (12) and thus eventually to the wheel brake (22) connected thereto. The second pressure medium channel is called a pressure channel (48) below. This channel connects the brake pressure generator (14) directly to the wheel brake (22), i.e., no pressure medium-controlling components are provided, so as to limit or direct, for example, a pressure medium flow in the pressure channel (48). The pressure on the wheel connection (20) thus corresponds to the brake pressure supplied by the brake pressure generator (14).

A third pressure medium channel forms a discharge channel (50). It branches away from the pressure channel (48) in the area between the brake pressure generator (14) and the wheel brake (22) and, in the exemplary embodiment shown, opens out into the supply channel (44) in an area between the plunger charging valve (46) and the pressure medium reservoir (18). The discharge channel (50) establishes a hydraulic connection between the wheel brake (22) and the pressure medium reservoir (18), which is controlled by a discharge valve (52). This is a normally open 2/2-way directional control valve, which is switchable by electrical control from a pass-through position into a blocking position. The directional control valve takes on the blocking position when a brake pressure is built up in the wheel brake (22) by the brake pressure generator (14) and is in the pass-through position when a highly dynamic pressure reduction is to be performed in the connected wheel brake (22), which cannot be accomplished by a movement of the brake pressure generator (14) in the pressure-reduction direction alone. The use of a normally open discharge valve (52) is advantageous because it allows for a pressure reduction even in the event of a malfunction, i.e., in a failure of the voltage supply, that is, when neither the discharge valve (52) nor the brake pressure generator (14) are electrically responsive to the electronic control unit (30).

As an alternative to a normally open discharge valve (52), the use of a discharge valve (52′) would be possible that is designed to be normally closed. In this case, however, a failure of the voltage supply would have to be anticipated by providing an additional compensation channel (57′) running parallel to the discharge channel (50), which connects the working chamber (36) of the brake pressure generator (14) with the pressure medium reservoir (18) and which opens out into the working chamber (36) of the brake pressure generator (14) in such a way that the piston (34) due to its movement within the cylinder (32) opens this compensation channel (57′) only when it has reached or assumed its initial or basic position. If the piston (34) is in its basic position, then the working chamber (36) has its maximum volume. Furthermore, the drive of the piston (34) must then be designed in such a way that, in the event of a voltage failure, the piston (34) can be moved back into its initial position by the pressure in the working chamber (36).

Pressure medium, which was drained via the discharge valve (52) into the pressure medium reservoir (18), must be replenished again for a subsequent braking operation in the working chamber (36) of the brake pressure generator (14). For this purpose, pressure medium flows from the pressure medium reservoir (18) via the supply channel (44) into the working chamber (36) as soon as the piston (34) is moved back into its basic position by the motor (16), the volume of the working chamber (36) gradually increases and the plunger charging valve (46) opens the pressure medium connection due to the negative pressure arising in the process.

FIG. 1 finally also discloses a lubricant channel (56) via which the pressure medium reservoir (18) is connected to a receiving groove in the cylinder (32), in which a sealing formation (60) sealing the piston (34) in the cylinder (32) is situated. Via this lubricant channel (56), hydraulic pressure medium reaches the sealing formation (60), lubricates it and thus prevents possible wear of the seal. Over its entire adjustment path, the piston (34) with its shaft is in mechanical contact with this sealing formation (60), so that no pressure medium can enter from the lubricant channel (56) into the drive chamber (38) or into the working chamber (36) of the brake pressure generator (14). As long as the sealing formation (60) is intact, no significant volume of pressure medium flows in the lubricant channel (56), but is merely held in reserve there.

The described brake actuator (10) works in normal operation as follows:

A motor vehicle equipped with a wheel-specific electrohydraulic brake actuator (10) is equipped with a device for specifying a braking request or braking event. This may be a conventionally actuated brake pedal, a brake lever or a sensor device, the respective actuation of which by a driver generates an actuation signal proportional to the braking event or the braking request. Alternatively, the actuation signal may be generated by an electronics if the electronics determined a critical driving condition of the vehicle or a hazardous driving situation. From the incoming braking request signal, the electronic control unit (30) ascertains a control signal for the motor (16) of the brake pressure generator (14) and, if needed, for the discharge valve (52), which thereby switches from its open basic position to a blocking position. The motor (16) drives the piston (34) of the brake pressure generator (14) in the pressure-buildup direction, so that pressure medium is displaced from the working chamber (36) in the direction of the wheel brake (22), until a brake pressure corresponding to the braking request has been reached in this wheel brake (22). The latter is monitored by the electronic control unit (30) by way of the pressure sensor (26).

When the desired brake pressure in the wheel brake (22) is reached, the forward motion of the motor (16) ends, while the discharge valve (52) continues to be energized. As a result, the discharge valve (52) remains closed and the brake pressure currently prevailing in the wheel brake (22) is maintained.

For a brake pressure reduction, the motor (16) of the brake pressure generator (14) is driven in the pressure-reduction direction so that the piston (34) moves backward, in the direction of its original basic position. In the process, the volume of the working chamber (36) of the brake pressure generator (14) increases continuously, whereby pressure medium flows out of the wheel brake (22) and into the working chamber (36) until finally the desired, now lower, pressure level has been established in the wheel brake (22).

If the brake pressure in the wheel brake (22) is to be reduced to zero, for example if there is no longer a braking request, then the piston (34) of the brake pressure generator (14) is moved back into its basic or initial position. In this initial position of the piston (34), the volume of the working chamber (36) has its maximum volume.

Due to an increase of the temperature of the pressure medium during a braking process, it is possible that the pressure medium has expanded in such a way that the pressure in the wheel brake (22) does not fall to zero, even though the piston (34) of the brake pressure generator (14) is already in the basic position. In order to deal with this case, in the basic position of the piston (34), the discharge valve (52) is controlled by the electronic control unit (30) in such a way that it opens the discharge channel (50) and thus establishes a hydraulic connection between the wheel brake (22) and the pressure medium reservoir (18). Because atmospheric pressure prevails in the pressure medium reservoir (18), a possibly existing residual pressure in the wheel brake (22) dissipates as a result.

However, the dynamics or the speed of a pressure reduction feasible by the brake pressure generator (14) is limited due to the mechanical conditions of its drive. If it is necessary due to the present braking case to reduce the pressure more quickly, that is, with a higher dynamics, this occurs by an interruption of the electrical control of the discharge valve (52) in the discharge channel (50). As a result, this discharge valve (52) returns to its basic position, driven by a return device, and opens the pressure medium connection between the wheel brake (22) and the pressure medium reservoir (18). The pressure medium that flowed from the wheel brake (22) into the pressure medium reservoir (18) is replenished following the brake pressure reduction, in that the discharge valve (52) is brought again into its blocking position, that is, is electrically controlled and the piston (34) of the brake pressure generator (14) is driven by the motor (16) back in the direction of its basic position. The volume of the working chamber (36) increasing in the process effects an underpressure in the pressure medium circuit, as a result of which the plunger charging valve (46) in the supply channel (44) opens and pressure medium flows from the pressure medium reservoir (18) into the working chamber (36). As soon as the piston (34) of the brake pressure generator (14) has again assumed its basic or initial position, the original initial conditions are reestablished and the brake actuator (10) is available for a subsequent brake pressure generation.

If instead of a normally open discharge valve (52), a normally closed discharge valve (52′) is used, its electrical control accordingly occurs in the reverse order as described above.

A limit value for a speed of a pressure reduction, starting at which a brake pressure reduction is no longer performed by the brake pressure generator (14) alone, was ascertained empirically and stored electronically in the electronic control unit (30) of the brake actuator (10).

The explained control of a brake actuator (10) according to the present invention is suspended, however, when, as a result of pressure medium having been discharged into the pressure medium reservoir (18) in connection with a brake pressure control, the piston (34) has moved forward to the extent that it has approached an outer end point or reversal point in the cylinder (32). In the process, the volume of the working chamber (36) has decreased to such a degree that the present pressure medium no longer suffices to perform emergency braking at maximum brake pressure. The position of the piston (34) within the cylinder (32) of the brake pressure generator (14) is given by the evaluation, on the part of the electronic control unit (30), of the angle-of-rotation signal of the motor (16) provided by the angle-of-rotation sensor.

In the event that a wheel-slip control process is running during a braking process, the brake pressure in the connected wheel brake (22) is controlled as required by energizing the motor (16) accordingly and thus moving the piston (34) of the brake pressure generator (14) forward or backward. In this case as well, as described above, pressure medium discharged via the discharge valve (52) is replenished following the termination of the wheel-slip control process by returning the piston (34) of the brake pressure generator (14) into its initial position while the discharge valve (52) is closed.

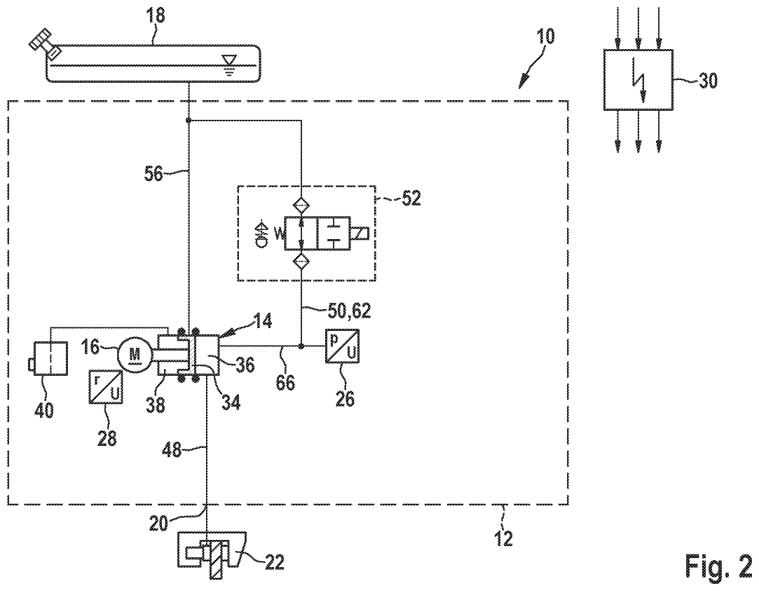

FIG. 2 shows a second exemplary embodiment of a wheel-specific, electrohydraulic brake actuator (10) according to the present invention. Aside from the missing plunger charging valve, the latter comprises the same components as the brake actuator (10) described in connection with FIG. 1. In the exemplary embodiment according to FIG. 2, the function of the plunger charging valve is assumed by the electrically controllable discharge valve (52), which for this purpose is installed at the original location of the plunger charging valve into the supply channel (44) between the pressure medium reservoir (18) and the working chamber (36) of the brake pressure generator (14).

Furthermore, in the second exemplary embodiment, the supply channel for the brake pressure generator (14) and its discharge channel are combined in a common pressure medium channel (62), which reduces the mechanical effort required for machining the housing block (12) and facilitates its more compact design.

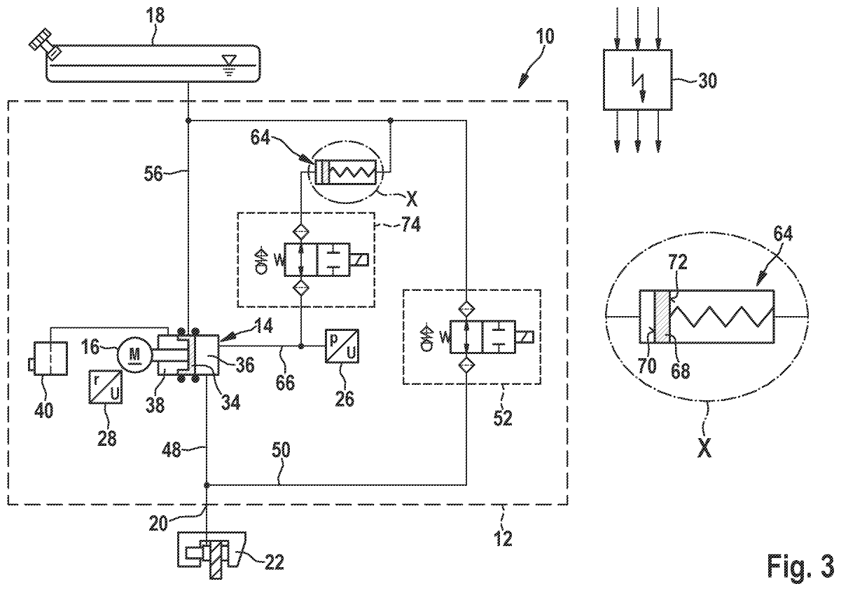

A third exemplary embodiment of the present invention is illustrated in FIG. 3. In addition to the components of the exemplary embodiment according to FIG. 1, it is equipped with a controllable low-pressure accumulator (64). The latter is provided for receiving pressure medium that is discharged from the wheel brake (22) when brake pressure is reduced. It is located at the end of a discharge branch (66), which is connected to the working chamber (36) of the brake pressure generator (14) in parallel to the discharge channel (50). The low-pressure accumulator (64; FIG. 3, detail X) comprises an accumulator piston (68) accommodated in a cylinder so as to be displaceable counter to the force of a return element, the accumulator piston (68) having a front side (70) facing the pressure medium circuit and a back side (72) acted upon by a return element. The back side (72) is hydraulically coupled to the pressure medium reservoir (18).

An application of pressure medium to the low-pressure accumulator (64) is controlled by an electrically controllable accumulator control valve (74). This accumulator control valve (74) is designed comparably to the discharge valve (52) as a normally open 2/2-way directional control valve, which is switchable by electrical control from a pass-through position into a blocking position.

When the accumulator control valve (74) is open, the low-pressure accumulator (64) is supplied with hydraulic pressure medium from the wheel brake (22) via the working chamber (36) of the brake pressure generator (14). In the process, the accumulator piston (68) is moved in the cylinder counter to the force of the elastic return element, for example a mechanical spring or an elastomer element. The pressure medium buffered in the low-pressure accumulator (64) is available to the brake pressure generator (14) as soon as its piston (34) is actuated in the pressure-reduction direction. Only in exceptional cases is it therefore necessary to compensate for a possible lack of pressure medium in the working chamber (36) of the brake pressure generator (14) with pressure medium from the pressure medium reservoir (18). In the third exemplary embodiment, the pressure medium channel present in addition to the discharge branch (66) and running from the wheel brake (22) to the pressure medium reservoir (18) acts again as a pure discharge channel, through which medium flows only in one direction, namely from the wheel brake (22) in the direction to the pressure medium reservoir (18).

The choice, whether the discharge branch (66) and/or the discharge channel (50) is or are used for a pressure reduction in the wheel brake (22) is determined by the electronic control unit (30) as a function of the braking event at hand or the required pressure-reduction dynamics and is implemented by electrically controlling the discharge valve (52) and/or the accumulator control valve (74) accordingly.

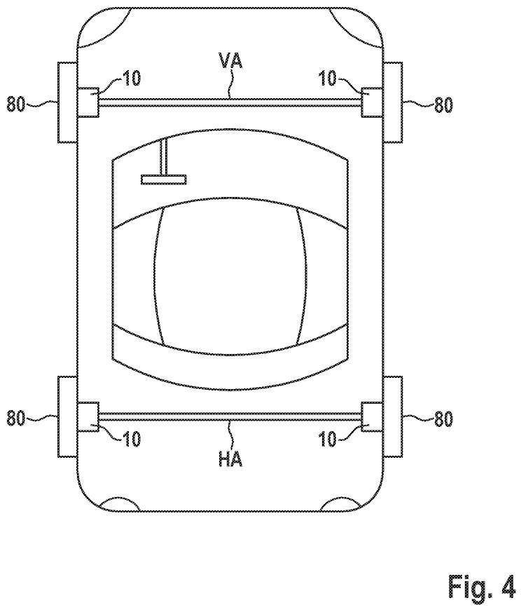

FIG. 4 shows in greatly simplified schematic fashion a vehicle including a vehicle brake system in a top view. The vehicle has a total of 4 wheels (80) distributed over 2 vehicle axles (VA, HA) and has per wheel (80) respectively one associated brake actuator (10), that is, in total 4 brake actuators (10). All existing brake actuators (10) may be of the same kind, although it is also possible that only the brake actuators of one axle are of the same kind and that the vehicle is accordingly equipped axle-wise with different brake actuators. Preferably, at least the front axle (VA) of the motor vehicle is equipped with wheel-specific electrohydraulic brake actuators (10) according to the present invention. At the wheel brakes of the rear axle (HA), it is possible to use electromechanical brake actuators, for example, instead of electrohydraulic brake actuators according to the present invention. Vehicle brake systems having different brake actuators are referred to as hybrid brake systems.

Of course, changes or additions to the described exemplary embodiments that go beyond these explanations are possible without the variants resulting therefrom departing from the scope of the present invention.

What is claimed is:

1. A wheel-specific, electrohydraulic brake actuator for controlling a brake pressure of a connectible wheel brake of a motor vehicle in a wheel slip-dependent manner, comprising:
a housing block;
a brake pressure generator situated on the housing block and actuatable by an electrically controllable motor, wherein the brake pressure generator includes a cylinder, a piston drivable by the motor to perform an axial movement within the cylinder, and a working chamber bounded by the cylinder and by the piston, and wherein a volume of the working chamber decreases when the piston is driven forward by the motor in a pressure-buildup direction and the volume of the working chamber increases when the piston is driven backward by the motor in a pressure-reduction direction;
a pressure channel from the brake pressure generator to a wheel connection of the housing block; and
an electronic control unit;
wherein the pressure channel directly connects the brake pressure generator to the wheel connection and the brake pressure generator is configured to increase, to maintain, and to lower a brake pressure on the wheel connection as needed.

2. The brake actuator as recited in claim 1, further comprising:
a pressure medium reservoir for storing hydraulic pressure medium; and
a discharge channel, between the brake pressure generator and the pressure medium reservoir, through which pressure medium is able to flow from the working chamber into the pressure medium reservoir;
wherein the discharge channel is controllable by an electrically controllable discharge valve.

3. The brake actuator as recited in claim 2, further comprising:
a compensation channel running parallel to the discharge channel between the brake pressure generator and the pressure medium reservoir, the compensation channel being controllable by the piston of the brake pressure generator in such a way that the compensation channel is open when the piston assumes a basic position and is closed as soon as the piston leaves the basic position.

4. The brake actuator as recited in claim 2, further comprising:
a supply channel for supplying the working chamber of the brake pressure generator with pressure medium; and
a hydraulically actuatable plunger charging valve which blocks in a direction of flow from the brake pressure generator to the pressure medium reservoir, for controlling a flow-through direction in the supply channel.

5. The brake actuator as recited in claim 4, wherein the supply channel, the pressure channel, and the discharge channel are formed as bores on the housing block.

6. A method for controlling a wheel-specific electrohydraulic brake actuator including:
a housing block,
a brake pressure generator situated on the housing block and actuatable by an electrically controllable motor, wherein the brake pressure generator includes a cylinder, a piston drivable by the motor to perform an axial movement within the cylinder, and a working chamber bounded by the cylinder and by the piston, and wherein a volume of the working chamber decreases when the piston is driven forward by the motor in a pressure-buildup direction and the volume of the working chamber increases when the piston is driven backward by the motor in a pressure-reduction direction,
a pressure channel from the brake pressure generator to a wheel connection of the housing block, and
an electronic control unit;
a pressure medium reservoir for storing hydraulic pressure medium, and
a discharge channel, between the brake pressure generator and the pressure medium reservoir, through which pressure medium is able to flow from the working chamber into the pressure medium reservoir,
wherein the discharge channel is controllable by an electrically controllable discharge valve;
wherein the pressure channel directly connects the brake pressure generator to the wheel connection and the brake pressure generator is configured to increase, to maintain, and to lower a brake pressure on the wheel connection as needed;
wherein the method comprises:
controlling the discharge valve controlling the discharge channel by the electronic control unit as a function of a braking request in such a way that the discharge valve blocks the discharge channel in the event of a brake pressure buildup by the brake pressure generator and otherwise opens the discharge channel.

7. The method for controlling the brake actuator as recited in claim 6, wherein the discharge valve controlling the discharge channel is controlled by the electronic control unit in such a way that pressure medium flows from the working chamber of the brake pressure generator via the discharge channel into the pressure medium reservoir when the electronic control unit has obtained information according to which a brake pressure reduction in the wheel brake is to be performed at a pressure reduction rate that is higher than a limit value for a pressure reduction rate stored in the electronic control unit.

8. The method for controlling a brake actuator as recited in claim 7, wherein the discharge valve controlling the discharge channel is controlled by the electronic control unit in such a way that the discharge channel is blocked when the electronic control unit has information according to which the volume of the working chamber of the brake pressure generator has reached or fallen below a minimum value stored in the electronic control unit.

9. An electronically slip-controllable vehicle brake system for a motor vehicle, comprising:
a plurality of wheel brakes; and
a device for electronic control of wheel slip on respectively associated wheels of the motor vehicle;
wherein the vehicle brake system has at least two wheel brakes, to each of which a wheel-specific, electrohydraulic brake actuator is assigned, the two wheel brakes being situated on a common axle of the motor vehicle, each of the brake actuators including:
a housing block,
a brake pressure generator situated on the housing block and actuatable by an electrically controllable motor, wherein the brake pressure generator includes a cylinder, a piston drivable by the motor to perform an axial movement within the cylinder, and a working chamber bounded by the cylinder and by the piston, and wherein a volume of the working chamber decreases when the piston is driven forward by the motor in a pressure-buildup direction and the volume of the working chamber increases when the piston is driven backward by the motor in a pressure-reduction direction,
a pressure channel from the brake pressure generator to a wheel connection of the housing block; and
an electronic control unit;
wherein the pressure channel directly connects the brake pressure generator to the wheel connection and the brake pressure generator is configured to increase, to maintain, and to lower a brake pressure on the wheel connection as needed.

10. The vehicle brake system according to claim 9, wherein the common axle is a front axle of the motor vehicle.
